(19) United States
(12) Patent Application Publication
(10) Pub. No.: US 2019/0264476 A1
(43) Pub. Date: Aug. 29, 2019

(54) Handle Unit with a Moveable Locking Cylinder

(71) Applicant: Huf Hülsbeck & Fürst GmbH & Co. KG, Velbert (DE)

(72) Inventors: Mirko Röhring, Essen (DE); Jörg Müller, Velbert (DE)

(21) Appl. No.: 16/311,133

(22) PCT Filed: May 16, 2017
(86) PCT No.: PCT/EP2017/061745

§ 371 Date: Dec. 18, 2018

(30) Foreign Application Priority Data
Jun. 30, 2016 (DE) 10 2016 112 038.3

(51) Int. Cl. E05B 85/06; E05B 85/10; E05B 79/06

(52) U.S. Cl. CPC E05B 85/06; E05B 85/10; E05Y 2900/531; E05Y 2900/546; E05B 79/06

(57) ABSTRACT

The present invention relates to a handle unit (10) for a moveable part (2) of a vehicle (1), comprising a mounting support (11) and a locking cylinder (12), characterized in that the locking cylinder (12) is moveably arranged on the mounting support (11), and is moveable in a fixing position (II) and in at least one mounting position (I).

The present invention relates to a handle unit for a moveable part of a vehicle according to the preamble of the independent device claim, as well as an as a mounting method for a door handle unit of a vehicle according to the independent method claim.

It is known from the prior art that locking cylinders are mounted on vehicle doors from the outside, wherein these locking cylinders mounted in this manner can be more easily manipulated. Moreover, locking cylinders are known in door handles for vehicles, which can be mounted from the inside. In generic locking cylinders, collisions with the locking cylinder frequently occur, however, in the mounting of the outer door handle.

It is the object of the invention to at least partially resolve the above disadvantages known from the prior art. In particular, it is object of the present invention to enable a simplified mounting of a handle unit for a moveable part of a vehicle.

The above object is achieved through a handle unit with the features of the independent device claim, and a method with the features of the independent method claim.

Further features and details of the invention result from the dependent claims, the description, and the drawings. Here, features and details, which have been described in conjunction with the device according to the invention, of course also apply in conjunction with the method according to the invention, and in each case vice versa, so that, with respect to the disclosure, reference is or can always mutually be made to the individual aspects of the invention.

Through the measures listed in the dependent claims, advantageous further developments and improvements of the inventive subject matters of the invention specified in the independent claims are possible.

According to the invention, the handle unit for a moveable part of a vehicle comprises a mounting support and a locking cylinder. The locking cylinder here is moveably arranged on the mounting support, and can be moved into a fixing position and at least one mounting position. In the fixing position, the locking cylinder is arranged on the mounting support in such a manner that, in the installed state of the handle unit in/on a moveable part of a vehicle, the locking cylinder can be accessible to a user from the outside. In the mounting position, the locking cylinder is arrangeable at an angle offset to the fixing position, arranged offset or rotated and/or displaced, in particular, in direction to the vehicle interior space. More free installation space or more free space is thereby available, in the mounting position, on the mounting support or the handle unit, so that the access to the mounting support from outside of the vehicle is improved. In particular, space for the mounting of further components in the region of the locking cylinder or the mounting support can thus be created. According to the invention, it is conceivable that the locking cylinder, in the mounting position, is arrangeable at an angle, rotated with respect to the fixing position, between approximately 1° and approximately 180°, preferably between approximately 10° and approximately 120°, particularly preferably between approximately 20° and approximately 90°.

Advantageously, the locking cylinder is substantially arranged on a side of the mounting support facing towards the vehicle interior space. In this case, the locking cylinder can, e.g. in the fixing position, at least in sections, be arrangeable flush on the side of the mounting support facing towards the vehicle interior space. In the mounting position, the locking cylinder can be arrangeable, rotated, and therefore, at least in sections, at a distance to the mounting support, further inside the moveable part. The locking cylinder is thereby additionally reliably protected against manipulations, which can be introduced in particular from outside of the vehicle. This is enabled in that essential parts of the locking cylinder are fastened or arranged onto a side of the mounting support facing towards the vehicle interior space, so that these parts are at least in sections, covered and thus protected by the mounting support. It is conceivable that an access to the locking cylinder from outside can be made possible only on the part of the locking cylinder, on which a mechanical key for the locking cylinder can be inserted. Furthermore, the locking cylinder, outside of the moveable part, can also be covered, at least in sections, by further components, which, in particular, are arrangeable in such a manner that the locking cylinder is accessible only by an action of the operator of a vehicle.

Advantageously, at least one mounting bearing can be arranged on the mounting support or on the locking cylinder, whereby the locking cylinder is pivotably mounted. In the context of the invention, pivotably means that the bearing can have at least one degree of freedom for a movement of the locking cylinder between the fixing position and the mounting position. According to the invention, it can here be provided that the movement occurs rotatory and/or translationally, wherein preferably a rotatory pivotal movement of the locking cylinder around the mounting bearing can be provided. The mounting bearing can thus make a simplified pivotal movement of the locking cylinder, in particular from the mounting position into the fixing position, and vice versa, possible. Here, the mounting bearing can also serve to make a guided movement of the locking cylinder between the fixing position and the at least one mounting position possible. It is furthermore conceivable that the mounting bearing comprises a toothing, whereby the locking cylinder is gradually moveable. A toothing and a locking tab can thus be provided, which is configured comparably to a cable tie, wherein the locking tab stands in mechanical operational connection with the toothing so that the locking tab can engage in the respective step/recess of the toothing. The locking cylinder can thereby be moved incrementally back and forth between the mounting position and the fixing position, wherein, simultaneously, an uncontrolled pivoting or slipping can be prevented in the mounting.

A rotary bearing, a linear bearing or a ball joint can an advantageously serve as a mounting bearing, wherein in particular the mounting bearing has at least two degrees of freedom. A rotary or radial bearing enables a rotation of the locking cylinder around the mounting bearing, wherein the rotating part is usually an axially-extending shaft. As a result, the locking cylinder and/or the mounting support can comprise a shaft axially extending in such a manner so that, in the installed state of the mounting support of the handle unit, the locking cylinder can rotatorily be moved around the axially-extending shaft. It is conceivable that a shaft is arranged or formed in the mounting support, and the locking cylinder is plugged onto the thus-configured shaft, wherein, due to the circular cross-section of the shaft, the locking cylinder can be rotatively rotated around the shaft. According to the invention, it is conceivable that the locking cylinder can be moved horizontally or vertically around a shaft or rotational axis. A shaft or axis can also thus be arranged or configured on the mounting support in a horizontal or vertical direction. A linear bearing is used to guide a straight movement between locking cylinder and the mounting support. Here it is conceivable that the locking cylinder can be displaced along the linear bearing between the fixing position and the mounting position. In addition, the mounting bearing can be configured as a ball joint, wherein in particular the mounting bearing has at least two degrees of freedom. The locking cylinder can be pivoted and/or rotated vertically, as well as also horizontally in a ball joint. The flexibility in the arrangement of the locking cylinder, in particular for the mounting position, can thus be increased, so that, depending upon the given or required space within the mounting support, or the interior space of the moveable part in the region of the locking cylinder, the locking cylinder can be freely moved between the fixing position and the mounting position. It is likewise conceivable that, through at least two degrees of freedom, the mounting bearing makes a horizontal as well as also a vertical movement of the locking cylinder possible, in particular between the mounting position and the fixing position. The locking cylinder can thus be displaced out of the mounting position, first along the mounting bearing, and subsequently rotated around an axis, in particular in the direction of the fixing position, and thus can be moved into the end position of the looking cylinder. A greatest-possible latitude in the achievement of free installation space within the handle unit, in particular the mounting bearing, is thus achieved.

Within the scope of the invention, at least one securing mechanism can be arranged on the mounting bearing and/or on the locking cylinder, whereby the locking cylinder is force-fittingly held in the fixing position. A securing mechanism according to the invention can make possible that the locking cylinder can be fastened in the end position in such a manner, that a further movement of the locking cylinder is prevented, and in particular said cylinder is secured against manipulation attempts. The securing mechanism here can be configured as a screw, in particular as a ferromagnetic screw. Via the at least one screw, the locking cylinder can be force-fittingly fixed to the handle unit, in particular to the mounting support. Advantageously, the screw is configured ferromagnetically, so that a simplified mounting of the screw inside the installation space made available can be made possible. Furthermore, the securing mechanism can be configured as a slide-, snap-in or as a latching-connection mechanism. Such manner of securing mechanisms achieve a force-fitting and/or form-fitting securing of the locking cylinder to the mounting support, wherein, in particular upon reaching the fixing position of the locking cylinder, a slide element, a snap-in or a latching connection can, between mounting support and locking cylinder, produce a force-fitting connection of the two components. It is likewise conceivable that the locking cylinder is initially rotated or displaced in the direction of the fixing position, and thereafter, is moved, through a second movement type, into the final fixing position, so that the securing mechanism is triggered and holds the locking cylinder force-fittingly in the fixing position. This way, a rotatory movement in the fixing position direction can first be performed, and subsequently, a translational movement can fix the locking cylinder in or with the securing mechanism. Likewise, this movement sequence can take place reversely, so that first a translatory and subsequently a rotatory movement until the reaching of the fixing position and a force-fitting connection with the securing mechanism is achieved.

Advantageously, the securing mechanism can be configured in such a manner that, by means of the securing mechanism, the locking cylinder is moveable into the fixing position, and, in the fixing position, can be force-fittingly fixed. Here, the securing mechanism can comprise a slotted guide, so that the locking cylinder runs first into the fixing position or the end position, along the slotted guide, and subsequently is force-fittingly fixed, via the securing mechanism, for example a screw, into the fixing position. Furthermore, it is conceivable that, via such a manner of securing mechanism, the locking cylinder, via a screw or a worm thread or slotted guide, is transferred first from the mounting position into the fixing position, and subsequently latches into the fixing position with the securing mechanism, for example in the form of a latching connection. This way, a simplified mounting and fixing of the locking cylinder on the mounting support or with the securing mechanism is achievable.

Within the scope of the invention, the locking cylinder can comprise a housing, in which the locking cylinder is arranged, wherein the mounting bearing and/or the securing mechanism is arranged on the housing. The housing here can additionally protect the locking cylinder against attempts at manipulation, and/or substantially seal it against outside influences, in particular environmental influences. To that end, it can be provided that at least one sealing element is provided on the housing, so that an ingress of moisture and/or dirt into the locking cylinder or between locking cylinder and housing can be prevented. Furthermore, the mounting bearing and/or the securing mechanism can be arranged on the housing. The housing can here preferably be configured in such a manner that the mounting bearing and/or the securing mechanism are arranged on/in the housing, and as a result, are arrangeable on the mounting support in such a manner that they can be better protected against attempts at manipulation and outside environmental influences.

The mounting bearing can comprise a guide contour, whereby the locking cylinder is translationally or rotatory moveable. Here, the mounting bearing can be equipped with a guide contour in such a manner that, in a rotatory movement along a rotational axis or a rotary bearing of the mounting bearing, the locking cylinder can translatorily be moved between the fixing position and the mounting position. The guide contour can therefore comprise a thread-like contour and/or a geometry that is correspondingly angled relative to the mounting support, so that a translational and rotative movement can be carried out simultaneously. More latitude or installation space is made available through a rotative and translational movement of the locking cylinder between the mounting position and the fixing position.

It is furthermore conceivable that the locking cylinder and/or the housing comprise a metallic material and a fiber-reinforced plastic, whereby the security against manipulation is increased. Here, it is conceivable that the locking cylinder and/or the housing can comprise a die-cast zinc (for example ZAMAC), a hardened steel, stainless steel and/or a fiber-reinforced plastic. The locking cylinder and/or the housing can thus be configured with an increased mechanical resistance so that in particular the security against break-ins and manipulations is increased.

Within the scope of the invention, a door handle can be provided, wherein the door handle can be brought into at least one closing position and at least one opening position, wherein the closing position of the locking cylinder, is at least in sections covered by the door handle, in sections, on a side facing away from the vehicle. The door handle here serves in particular to mechanically actuate a door lock, and can, according to the invention, comprise a cavity or receptacle in the door handle housing, so that, in the closing position, the locking cylinder can at least in sections be received in this receptacle or cavity and thus is covered in the closing position by the door handle. These types of door handles can also be configured with an aperture in the region of the locking cylinder, wherein the aperture is dimensioned in such a manner that a key for the locking cylinder is insertable into this aperture. Here, the door handle can protect the lock cylinder against outside influences, and can make an optically pleasant impression of the handle unit possible. It can thereby be achieved that the locking cylinder is not immediately visible from outside, and merely the door handle can be recognized by a user outside of the vehicle. Only in an actuation of the door handle from the closing position into an opening position is the locking cylinder at least in sections uncovered.

Advantageously, at least the mounting support, the mounting bearing, the door grip, or the housing can be an injection-molded part, in particular a 2-component injection-molded part. In a 2-component injection-molded part, it is conceivable that the mounting support, the mounting bearing, the door handle, and/or the housing comprise materials with different mechanical properties. This way, a harder material can be provided on locations with higher load than on locations with lower load. Thus, on the one hand, costs can be saved and/or the mechanical and/or chemical durability of the components can be increased. Simultaneously, injection-molded parts make a cost-effective and simple production method possible, wherein the shaping of the injection-molded components is, in a simple manner, variable or simply adjustable.

It is furthermore conceivable that a door handle finger guide is formed on the mounting support and/or on the housing, whereby the door handle finger is guided, in particular during a movement of the door handle. A door handle finger guide according to the invention thus serves to guide the part of the door handle which, spaced next to the locking cylinder, engages into the movable part, in particular the door of a vehicle. To that end, the door handle finger guide can comprise a corresponding slotted guide, which is configured geometrically complementarily to the door handle finger, so that the door handle finger is guided within the slotted guide and merely permits a translational movement of the door handle finger into the moveable part or out of the moveable part. Thus, a haptically high-value impression of the door handle results, in particular during a movement of the door handle from the closing position into an opening position, and vice versa.

Advantageously, a spring element can be arranged at least on the mounting bearing, the locking cylinder, the housing, and/or the mounting support, whereby the locking cylinder is held in the fixing position, and can be transferred into the mounting position in an application of force against the spring force. A spring element of this manner can be configured as a coil spring or as a leg spring, wherein the spring element is arranged on the mounting bearing, the locking cylinder, the housing or the mounting support in such a manner that the spring force transfers the locking cylinder into the fixing position. It is conceivable that, in a leg spring, the one leg is arranged on the locking cylinder or the housing of the locking cylinder and the other leg is arranged on the mounting support, so that, due to the bending moment of the leg spring, the locking cylinder is pressed around the mounting bearing in the fixing position. If the locking cylinder is now transferred from the fixing position into the mounting position by means of an application of force, for example in order to mount or place a door handle, from the outside, on the moveable part, in particular the handle unit, thus it is possible, in overcoming the torque applied by the spring element, to press the locking cylinder into the mounting position. After the mounting, the locking cylinder is automatically transferred back into the fixing position, so that the locking cylinder can finally be force-fittingly fixed to the mounting support. According to the invention, it is likewise conceivable that the spring element transfers the locking cylinder, due to the torque, into the mounting position and, only in an application of force and an overcoming of the torque of the spring element, the locking cylinder is transferable into the fixing position, and can be fixed to the mounting support.

Within the scope of the invention, the door handle can comprise a recess, wherein the locking cylinder, in the closing position, is, at least in sections, in particular form-fittingly arrangeable in the receptacle. Here, the door handle can comprise a cavity, in which the locking cylinder is covered in the closing position, and thus is substantially not visible from the outside. Here, it is conceivable that a sealing element is arranged in the recess so that the locking cylinder is additionally secured against outside influences. Simultaneously, the recess of the door handle can comprise a material aperture, for example in the form of a borehole and/or a material recess, so that a key for the locking cylinder is insertable.

According to a further aspect of the invention, a mounting method for a door handle unit of a vehicle, in particular according to one of the preceding claims, is claimed. Here, the mounting method comprises at least the following steps:
a) fastening of a mounting support on a side of a moveable part facing the vehicle interior space, in particular a door or a tailgate or a trunk lid, wherein a locking cylinder is arranged on the mounting support, which is moveable in a fixing position and in at least one mounting position,
b) mounting of a door handle on the mounting support from a side of the moveable part facing away from the vehicle interior space,
c) moving of the locking cylinder from the mounting position into the fixing position,
d) fastening of the locking cylinder on the mounting support by means of at least one locking mechanism.

As a result, the same advantages as had already been described in conjunction with the handle unit result for the mounting method according to the invention. The locking cylinder is preferably arranged on a side of the mounting support facing the vehicle interior space, is mounted in particular on a mounting bearing, and is here located in the mounting position, so that it is arranged, at a distance to the mounting support, at an angle offset to the fixing position. In the mounting position, an enlarged installation space is present in the region of the locking cylinder so that, in a subsequent mounting of a door handle on the mounting support of a side of the moveable part directed away from the vehicle interior space, a collision of the door handle, in particular of the door handle finger with a locking cylinder can be prevented. After the mounting of the door handle on the mounting support, the locking cylinder can be moved from the mounting position into the fixing position. Subsequent thereto, the locking cylinder is fastened to the mounting support by means of at least one locking mechanism, so that the locking cylinder and the door handle are mounted, ready for operation, on the handle unit.

Further measures improving the invention result from the following description regarding some exemplary embodiments of the invention, which are schematically represented in the figures. All features and/or advantages resulting from the claims, the description or the drawings, including constructive details, spatial arrangement, and method steps, can be essential to the invention by themselves, as well as also in various combinations. Here, it should be noted that the figures are only of descriptive nature, and are not intended to limit the invention in any way.

In the following embodiments, the same or equivalent elements are denoted by identical reference characters, and the repeated description thereof is omitted.

The Figures show in:

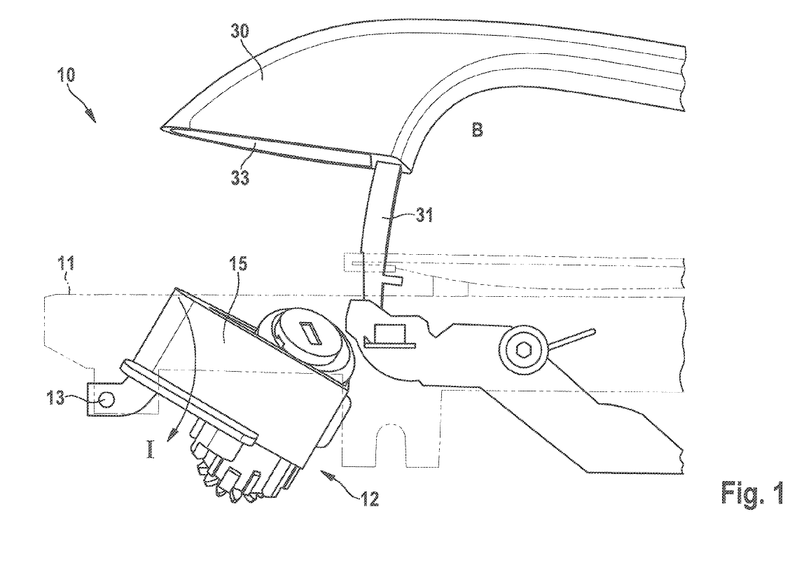

FIG. 1 a handle unit according to the invention in a first embodiment and in the mounting position,

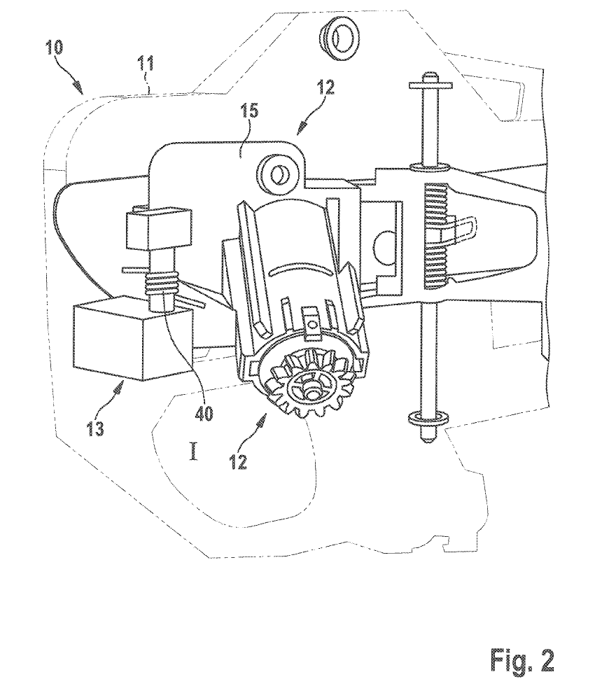

FIG. 2 a further embodiment of the handle unit according to the invention in the mounting position,

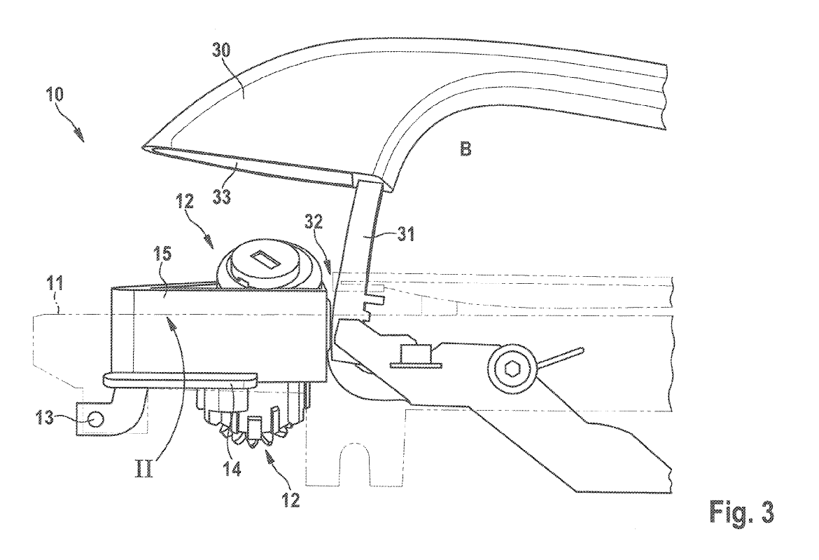

FIG. 3 a further embodiment of the handle unit according to the invention in the fixing position and

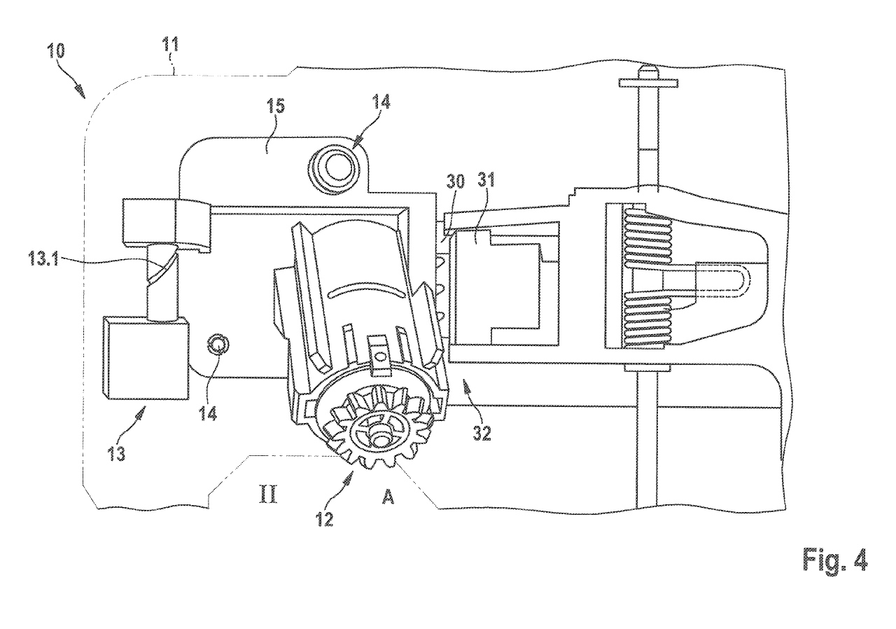

FIG. 4 the exemplary embodiment from FIG. 3 from a further perspective.

In FIG. 1, a first embodiment of the handle unit 10 according to the invention is represented. The handle unit 10 comprises a mounting support 11 with a locking cylinder 12 arranged thereon. The locking cylinder 12 comprises a housing 15 with a mounting bearing 13 arranged thereon, which is operatively connected with the mounting support 11. The locking cylinder 12 is in the mounting position I in FIG. 1 and the door handle 30 is in the opening position B. The door handle 30 furthermore comprises a door handle finger 31 and a receptacle 33 for the locking cylinder 12. The locking cylinder 12 is, in FIG. 1, pivoted around the mounting bearing 13, offset to the fixing position II, at an angle to the mounting support 11, in the direction of the vehicle interior space. A collision-free mounting of the door handle 30 is thereby possible, without the door handle finger 31 colliding with the locking cylinder 12, in particular the housing 15 of the locking cylinder 12.

In FIG. 2, a further embodiment of the handle unit 10 according to the invention is shown, wherein the locking cylinder 12 is located in the mounting position I. The handle unit 10 comprises, in FIG. 2, a mounting support 11 and a mounting bearing 13 arranged on the mounting support 11. The mounting bearing 13 comprises a rotational axis, on which a part of the housing 15 of the locking cylinder 12 is arranged. Furthermore, a spring element 40, in the form of a leg spring 40, is formed on the rotational axis of the mounting bearing 13, wherein the one leg spring 40 is operatively connected with the housing 15 of the locking cylinder 12, and a different leg of the spring element 40 is operatively connected with the mounting support 11.

FIG. 3 shows a further exemplary embodiment of the handle unit 10 according to the invention, comprising a mounting support 11 and a locking cylinder 12, wherein the locking cylinder 12 is located in the fixing position II. The locking cylinder 12 or the housing 15 of the locking cylinder 12 is also, in FIG. 3, moveably arranged on the mounting support 11 via a mounting bearing 13. In FIG. 3, the locking cylinder 12 is substantially arranged on a side of the mounting support 11 facing the vehicle interior space, and is, with the help of the securing mechanism 14, fixed force-fittingly to the mounting support 11. The securing mechanism 14, in FIG. 3, shows a screw, with which the locking cylinder 12 can be transferred from the mounting position I into the fixing position II, and is subsequently force-fittingly fixed to the mounting support 11. Furthermore, a door handle finger guide 32 for the door handle finger 31 of the door handle 30 is arranged on the housing 15 of the locking cylinder 12. In the fixing position II of the locking cylinder 12, the door handle finger 31 can now be guided along the door handle finger guide 32, between the opening position B and the closing position A of the door handle 30. The door handle 30 furthermore comprises a receptacle 33 for the locking cylinder 12 or a part of the housing 15 of the locking cylinder 12. The receptacle 33 is configured in the form of a cavity in the housing 15 of the door handle 30, and is geometrically dimensioned in such a manner that the housing 15 or the locking cylinder 12 is at least in section covered by the receptacle 33.

FIG. 4 shows a further view of the embodiment, shown in FIG. 3, of the handle unit 10 according to the invention. The handle unit 10 comprises a mounting support 11 with a mounting bearing 13 here, wherein the locking cylinder 12, with its housing 15, is moveably arranged on the mounting bearing 13. In the shown fixing position 2, the locking cylinder 12 is, via the securing mechanism 14, force-fittingly connected to the mounting support 11. The securing mechanism 14 comprises a screw 14 here, which fixes the housing 15 of the locking cylinder 12 to the mounting support 11, wherein the securing mechanism 14 likewise comprises a snap-in or latching mechanism 14 in the region of the mounting bearing 13. The housing 15 of the locking cylinder 12 is, in the shown securing mechanism 14, transferred, via the screw 14, from the mounting position I into the fixing position II, and, upon reaching the fixing position II, the housing 15 of the locking cylinder 12 latches onto a snap-in or latching mechanism 14 on the mounting bearing 13. As a result, the locking cylinder 12 is force-fittingly held, via the screw 14, as well as also via the snap-in or latching mechanism 14, on the mounting bearing 13. Furthermore, the door handle 30, in FIG. 4, finds itself in closing position A, wherein the door handle finger 31 is guided along the door handle finger guide 32 of the housing 15 of the locking cylinder 12. In FIG. 4, furthermore the mounting bearing 13 is configured as a rotary bearing. Furthermore, the mounting bearing 13 comprises a guide contour 13.1, whereby the locking cylinder 12 or the housing 15 is translationally, as well as also rotatory moveable.

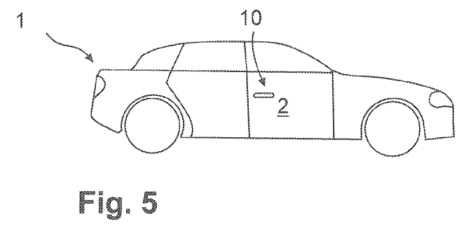

FIG. 5 shows a vehicle is 1 with a moveable part 2, wherein a door handle unit 10 according to the invention is arranged on the moveable part 2.

### LIST OF REFERENCE CHARACTERS

1 vehicle
2 moveable part
10 handle unit
11 mounting support
12 locking cylinder
13 mounting bearing
13.1 guide contour
14 securing mechanism
15 housing
30 door handle
31 door handle finger
32 door handle finger guide
33 receptacle
40 spring element
A closing position
B opening position
I mounting position
II fixing position

1-15. (canceled)

16. A handle unit for a moveable part of a vehicle, comprising a mounting support and a locking cylinder,
wherein
the locking cylinder is moveably arranged on the mounting support, and is moveable in a fixing position and in at least one mounting position.

17. The handle unit according to claim 16,
wherein
the locking cylinder is substantially arranged on a side of the mounting support facing the vehicle interior space.

18. The handle unit according to claim 16,
wherein
at least one mounting bearing is arranged on the mounting support or on the locking cylinder, whereby the locking cylinder is pivotably mounted.

19. The handle unit according to claim 18,
wherein
the mounting bearing is configured as a rotary bearing, a linear bearing or a ball join.

20. The handle unit according to claim 16,
wherein
at least one securing mechanism is arranged at least on the mounting support or on the locking cylinder, whereby the locking cylinder is force-fittingly held in the fixing position.

21. The handle unit according to claim 20,
wherein
the securing mechanism is configured in such a manner that, by means of the securing mechanism, the locking cylinder is moveable in the fixing position, and can be force-fittingly fixed in the fixing position.

22. The handle unit according to claim 16,
wherein
the locking cylinder comprises a housing, in which the locking cylinder is arranged, wherein at least the mounting bearing or the securing mechanism is arranged on the housing.

23. The handle unit according to claim 16,
wherein
the mounting bearing comprises a guide contour, whereby the locking cylinder is translationally and rotatory moveable.

24. The handle unit according to claim 16,
wherein
at least the locking cylinder or the housing comprise at least a metallic material or a fiber-reinforced plastic, whereby the security against manipulation is increased.

25. The handle unit according to claim 16,
wherein
a door handle is provided, wherein the door handle can be brought into at least one closing position and one opening position, wherein, in the closing position, the locking cylinder is, at least in sections, covered on a side facing away from the vehicle.

26. The handle unit according to claim 16,
wherein
at least the mounting support, the mounting bearing, the door handle or the housing is an injection-molded part.

27. The handle unit according to claim 16,
wherein
a door handle finger guide is formed at least on the mounting support or on the housing, whereby the door handle finger is guided.

28. The handle unit according to claim 16,
wherein
a spring element is arranged at least on the mounting bearing, the locking cylinder, the housing or the mounting support, whereby the locking cylinder is held in the fixing position, and can be transferred, in application of force against the spring force, into the mounting position.

29. The handle unit according to claim 16,
wherein
the door handle comprises a receptacle, wherein the locking cylinder, in the closing position, at least in sections, is arrangeable in the recess.

30. A mounting method for a handle unit of a vehicle, comprising the following steps:
a) fastening of a mounting support on a side of a moveable part facing the vehicle interior space, wherein a locking cylinder is arranged on the mounting support, which locking cylinder is moveable into a fixing position and at least one mounting position, wherein the locking cylinder is located in the mounting position,
b) mounting of a door handle on the mounting support from a side of the moveable part facing away from the vehicle interior space,
c) movement of the locking cylinder from the mounting position into the fixing position,
d) fastening of the locking cylinder on the mounting bearing by means of at least one locking mechanism.

31. The handle unit according to claim 19,
wherein
the mounting bearing has at least two degrees of freedom.

32. The handle unit according to claim 26,
wherein
the injection-molded part is a 2-component injection-molded part.

33. The handle unit according to claim 27,
wherein
the door handle finger is guided during a movement of the door handle.

34. The handle unit according to claim 29,
wherein
the locking cylinder is form-fittingly arrangeable in the recess.

35. The mounting method according to claim 30,
wherein in step a) the fastening of the mounting support on the side of the moveable part faces a door or a tailgate.
